(19) United States
(12) Patent Application Publication
(10) Pub. No.: US 2005/0123686 A1
(43) Pub. Date: Jun. 9, 2005

(54) Amorphous metal deposition and new aluminum-based amorphous metals

(76) Inventor: James J. Myrick, Glencoe, IL (US)

Correspondence Address: James J. Myrick, 748 Greenwood Avenue, Glencoe, IL, 60022, US

(21) Appl. No.: 10/943,623

(22) Filed: Sep. 17, 2004

Related U.S. Application Data
(60) Provisional application No. 60/504,370, filed on Sep. 19, 2003.

(51) Int. Cl. H05H 1/26; B05D 1/08

(52) U.S. Cl. 427/446

(57) ABSTRACT

Methods for applying an amorphous metal alloy to a substrate, comprising the steps of vaporizing an amorphous metal alloy composition, in a plasma spray gun to form a metal alloy vapor plasma plume, directing the metal alloy vapor plume onto a cooled substrate, maintained and condensing and rapidly solidifying the amorphous metal alloy composition vapor on the substrate, to form an amorphous metal layer deposit of high density and strength.

### CROSS-REFERENCE TO RELATED APPLICATION

This application claims the benefit of the filing date of U.S. Provisional Application No. 60/504,370 filed Sep. 19, 2003.

### FIELD OF THE INVENTION

The present invention is directed to deposition of amorphous metal coatings, layers and forms by thermal spray processes, as well as new aluminum-based amorphous alloys.

### BACKGROUND OF THE INVENTION

Thermal spray processes, such as plasma jet and high velocity oxygen fuel (HVOF) processes are conventionally used to apply particles to form surface coatings on appropriate substrates. However, thermal spray processes have some disadvantages, such as the difficulty of producing adherent, porosity-free coatings with a strong bond to the substrate. Typically the substrate surface must be roughened, so that the thermally sprayed particles can form a relatively low-strength mechanical bond with the substrate. The inherent porosity of thermally-sprayed coatings can be reduced by carrying out the process under vacuum, although this does increase the cost and complexity of the process, and by using high particle velocity such as provided by HVOF systems. The bond strength of thermally sprayed coatings with metallic substrates has been improved by making the substrate a continuous cathode for the direct-current plasma plume, but this may increase the resistive heating at the surface where the thermally sprayed particles are being deposited.

Thermal spray processes are also used to apply amorphous metal coatings to substrates. In these processes, the powder is melted by plasma or HVOF gun, and the molten droplets form “splats” on the substrate which cool to form the surface coating. “Ordinary” amorphous metals must be cooled from the melt at extremely high rates, to prevent crystallization. However, some amorphous metals are more stable to devitrification at much lower cooling rates. Such amorphous alloys, known generally as Bulk Metallic Glasses (“BMG”) can be based on Zr, Ti, Fe, Co, Ni, Mg, La, Pd, and/or Cu as the main element, typically combined with small metalloids (B, C, Si, P) and other transition elements, and/or small amounts of larger refractory or lanthanide metals to form a high-viscosity melts with a low crystallization energy. However, even bulk metal glasses do not generally produce fully dense and fully amorphous coatings when applied with thermal spray processes.

Thermal spray processes have also been studied for applying particles of ultra hard materials such as AlMgB₁₄ based compositions to coat substrates, but such HVOF processes will tend to oxidize such materials and have limited substrate and/or interparticle bonding strength.

In addition, there is a need for lightweight amorphous alloys, such as aluminum and/or silicon-based amorphous alloys which have desirable performance characteristics.

### SUMMARY OF THE INVENTION

This invention is directed to thermal spray methods, particularly including plasma processing methods, for vaporizing small powders of metals/metalloids of specific compositions to form a vapor of a desired alloy, such as an amorphous metal alloy composition and/or an ultra hard alloy composition, and for condensing the vapor on a metal or other suitable surface. In the case of amorphous alloys, the substrate is maintained at a temperature below the crystallization temperature of the amorphous metal alloy and preferably in the case of BMG alloys, below the glass transition temperature of the amorphous metal alloy. The amorphous metal vapor condensed on the metal surface can provide a good bond (e.g., compared to the purely mechanical bond which is typical using thermal powder spray using substantially only relatively large powders) and high density of the deposit. The cooled condensed vapor forms a solid amorphous metal alloy, and the vapor may continue to be condensed and cooled onto the previously deposited amorphous alloy to form layers and shapes of arbitrary thickness. If the plasma is a chemically reducing plasma (e.g., with at least some hydrogen content) capable of preventing or removing surface oxide on the metal substrate, a metallurgical bond may be formed between the deposited metal vapor alloy mixture and the substrate.

While some amorphous metals fully or partially crystallize over a limited period of time at temperatures coextensive with or only slightly above their effective glass transition temperature, a wide variety of amorphous metal compositions are relatively stable at temperatures at or slightly above their glass transition temperature, Tg, and do not initiate substantial crystallization unless raised to a crystallization temperature, Tx, which may be 10 to 100 or more degrees Celsius higher than Tg. By “bulk metal glass” (BMG) is meant an amorphous metal alloy composition having a glass transition temperature, Tg, at which it exhibits a supercooled liquid phase for at least one second, and preferably at least 30 seconds.

The glass transition temperature Tg (if any) and the crystallization temperature(s) Tx of an amorphous alloy are typically determined by differential scanning calorimetry, in which the temperature of a sample is slowly raised, and correlated, as a function of temperature, with the amount of energy necessary to raise the temperature. The glass transition phase change is typically an endothermic process involving slight volume increase, while crystallization is typically an exothermic process involving slight volume decrease. Many, if not most, amorphous metal compositions do not have a glass transition temperature, but instead crystallize at one or more elevated temperatures without going through a distinct viscous glass transition phase. An amorphous metal composition may have a number of distinct crystallization temperatures Tx(1), Tx(2) . . . at which various components crystallize or recrystallize from components crystallized in a less stable or metastable crystalline phase at a lower crystallization temperature. As will be discussed, a variety of amorphous metal alloys have a distinct glass transition Tg, at which they undergo a slight volume expansion upon phase transition to a viscous glass state, and undergo partial crystallization, typically forming nanoscale crystallites in an amorphous matrix which remains in a viscous glassy state. These partially-nano-crystalline bulk metal glasses retain a viscous glassy matrix above Tg, and are useful in the present methods and are considered to have a supercooled liquid temperature region in which they form a viscous glass, albeit one with nanoscale crystallites at high temperatures, still below their metal temperature Tm, they will fully crystallize and lose their viscous , supercooled glass condition. The determination of glass transition temperature and crystalline temperature(s) is typically a function of the rate at which the temperature of the metal glass foam is increased. For purposes of this disclosure, a rate of temperature increase of 0.25 degrees Celsius per second may be used to determine Tg, although other rates are used in determining reported Tg and Tx values herein.

Bulk metal glasses (BMGs) used herein preferably have a crystallization temperature, Tx, which is at least 20° C. and more preferably at least 40° C. higher than the glass transition temperature, Tg, of the bulk metal glass.

Amorphous metal alloys may have exceptionally high impact resistance and strength, which are important qualities for various metal product, coatings and components. For example, Bulk Metal Glasses (BMGs) based on Fe, Zr, Ti, Cu, Mg and/or Al metal systems can exhibit unique combinations of high hardness, strength, toughness and corrosion resistance. BMG alloys such as Fe—(Zr,Ti,Ni,Co,Mo)—(B,C,Si,P); Zr—Ni—Al—Cu; and Zr—Ti—Cu—Ni—(Si,Be) exhibit very good bulk glass-forming ability with high thermal stability in the supercooled glass state, and low critical cooling rates. [See, e.g., U.S. Pat. No. 6,258,185, “Methods of Forming Steel” to Branagan et al (2001); A. Inoue, et al., Mater. Trans. JIM, 31 (1991), p. 425; T. Zhang, et al., Mater. Trans. JIM, 32 (1991), p. 1005; A. Inoue et al., Mater. Trans. JIM, 32 (1991), p. 609; A. Peker, et al., Appl. Phys. Lett., 63 (1993), p. 2342.

The toughness of amorphous metals, including bulk metal glasses (BMGs) can increase with increasing impact or shear rates, to relatively high levels. The more stable BMG alloys typically form dense, deep eutectic liquids with relatively small free volume, and relatively high melt viscosity, above their glass transition temperature, Tg. They typically comprise three, and preferably four or more components having negative heats of mixing and at least 12% difference in atomic size, in proportions which permit high packing density and short-range order. Being energetically close to the crystalline state in this manner, can provide slow crystallization kinetics, with high viscosity and high glass forming ability. R. Busch, “The Thermophysical Properties of Bulk Metallic Glass-Forming Liquids”, JOM, 52:7 (2000), pp. 39-42. However, the thickness of amorphous metal alloys which can be formed directly by casting from the melt is generally limited by the cooling rate and thermal conductivity. By condensing plasma-vaporized amorphous metal alloys on a suitable substrate in accordance with the present disclosure, relatively thick coatings and product shapes may be manufactured.

In conventional thermal spray processes, relatively large metal particles (e.g., 30-150 micron-sized particles) are introduced into a fast-moving plasma or HVOF jet, and at least partially melted while being accelerated toward a target surface.

The (partially) molten particles “splat” on the surface and are solidified. The speed at which the “splats” can cool is limited by their thickness, and even BMG thermally sprayed alloys may slow some crystallization under such standard conditions, particularly if “splatted” on a crystalline surface. In accordance with the present disclosure, small metal/metalloid particles of particle size less than about 10 microns, and preferably about 6 mircons or less, are introduced into a very hot plasma (e.g., at least 10,000° K., and preferably over 15,000° K. to as much as 25,000° K. or more) where they are substantially vaporized in view of their high surface area to volume ratio. Inert gas-vacuum or other suitable atomization processes may be used to produce amorphous metal alloy powders of small particle size for vaporization in accordance with the present disclosure. Inert gas atomization is particularly preferred in which the metal/metalloid alloy components are melted to form a uniform amorphous or BMG alloy mixture in an induction furnace, arc furnace or other suitable furnace, and the homogeneous liquid metal melt is dispersed into individual particles in an atomizing chamber where it is contacted by a high velocity stream of the atomizing inert gas. The molten metal stream is disintegrated into fine droplets which may solidify from the direct cooling effects of the atomizing gas, or more indirectly during their fall through an atomizing tank. It is not necessary that the small alloy particles be in an amorphous state, because they will be vaporized in the deposition process. Particles are collected at the bottom of the tank. Alternatively, centrifugal force can be used to break up the liquid as it is removed from the periphery of a rotating electrode or spinning disk/cup. Powders used for spraying may be prepared by vacuum gas atomization and then crushed by a centrifugal mill, ball mill, attention mill, or other suitable comminution.

Similarly, mechanical powder forming methods, such as milling may also be used for reducing the size of larger particles and particle agglomerates and for making uniform blends. Ball, hammer, vibratory, attrition, and tumbler mills are some of the commercially available comminuting devices. Impact, attrition, shear, and compression all influence powder particle size composition and crystal (or amorphous) structure. Liu, Y. J. and I. T. H. Chang (2002). “The correlation of microstructural development and thermal stability of mechanically alloyed multicomponent Fe—Co—Ni—Zr—B alloys.” Acta Materialia 50(10 June 12): 2747-2760 describe formation of multicomponent Fe70-x-yCoxNiyZr10B20 (x=0, 7, 21; y=7, 14, 21, 28) alloys by high energy ball milling. Zhang, L. C., E. Ma, et al. (2002). “Mechanically alloyed amorphous Ti50(Cu0.45Ni0.55)44-xAlx Si4B2 alloys with supercooled liquid region.” Journal of Materials Research 17(7 July): 1743-1749 describe production of amorphous Ti50(Cu0.45Ni0.55)44-xAlx Si4B2 (x=0, 4, 8, 12) alloy powders with a well-defined glass transition and a supercooled liquid region (delta-Tx=64 K). In this regard, see also Zhang, L. C. and J. Xu (2002). “Formation of glassy Ti50Cu20Ni24Si4B2 alloy by high-energy ball milling.” Materials Science Forum Proceedings of the International Symposium on Metastable, Mechanically Alloyed and Noncrystalline Materials (ISMANAM), Jun. 24-29, 2001 386-388: 47-52.

Chemical and electrochemical methods may also be used to produce suitable small particle amorphous alloy powders. Included are the production of metal powders by the reduction of metallic oxides, precipitation from solution (hydrometallurgy), and thermal decomposition of metal carbonyl compounds. Precipitation of metal alloys from aqueous or nonaqueous solutions can be accomplished by using electrolysis and/or chemical reduction.

### DESCRIPTION OF THE DRAWINGS

FIG. 1 is a schematic illustration of thermal spray apparatus for carrying out certain embodiments of the present invention; and

FIG. 2 is a cross-sectional view of the plasma gun of the apparatus of FIG. 1.

### DETAILED DESCRIPTION OF THE INVENTION

Alloys and/or blends of small powder components are fed into a plasma gun to vaporize the powders to form BMG amorphous metal vapor mixtures. By condensing these vapor mixtures on a cool (preferably metal) substrate, the condensate can immediately cooled below its glass transition temperature before crystallizing, and can remain amorphous. It is preferable to limit or avoid oxidation, particularly when vaporizing highly reactive elements, and to control the substrate-surface-cooling temperature. Desirably, if an amorphous alloy layer is to be deposited, the substrate will be maintained during the deposition at a temperature at least 50° C. and more preferably at least 100° C. below the crystallization temperature of the alloy being deposited on the substrate. If the alloy being deposited is a Bulk Metal Glass, the substrate is preferably cooled to a temperature at least 50° C., and more preferably at least about 100° C. below the glass transition temperature Tg of the alloy being deposited.

The vapor is cooled rapidly enough to a temperature below the Tx or Tg of the condensed amorphous or BMG alloy, that the appropriate amorphous metal alloy composition is condensed and deposited on the substrate and solidified in an amorphous state. Amorphous metal coatings are strong, resist corrosion, and can be converted to hard, wear resistant surfaces upon appropriate nanocrystallization conditions.

As indicated, the vaporized alloy components are condensed on the substrate. However, because different metal and metallized components of various alloys have different vaporization and condensation characteristics, depending on factors including the temperature of the substrate (which is much lower than the vaporized alloy components), pressure and the volume of inert gas carrying the alloy vapor, the composition of the alloy condensed on the substrate may differ from the composition of the vaporized components.

In this regard, the following table lists the temperature in degrees Celsius at which the vapor pressure of selected metal and metallized elements is, respectively, 1×10⁻² Torr, and 1 Torr.

Vapor Pressure Data for Selected Elements

| | Element | 10⁻² Torr | 1 Torr |
|---|---|---|---|
| Al | Aluminum | 1,217° C. | 1,557° C. |
| B | Boron | 2,027° C. | 2,507° C. |
| Ba | Barium | 610° C. | 852° C. |
| Be | Beryllium | 1,227° C. | 1,557° C. |
| C | Carbon | 2,457° C. | 2,897° C. |
| Ca | Calcium | 597° C. | 802° C. |
| Co | Cobalt | 1,517° C. | 1,907° C. |
| Cr | Chromium | 1,397° C. | 1,737° C. |
| Cu | Copper | 1,257° C. | 1,617° C. |
| Dy | Dysprosium | 1,117° C. | 1,437° C. |
| Fe | Iron | 1,477° C. | 1,857° C. |
| Ge | Germanium | 1,397 | 1,777° C. |
| La | Lanthanum | 1,727° C. | 2,177° C. |
| Li | Lithium | 537° C. | 747° C. |
| Mg | Magnesium | 439 | 605° C. |
| Mn | Manganese | 937° C. | 1,217° C. |
| Mo | Molybdenum | 2,527° C. | 3,117° C. |
| Nb | Niobium | 2,657° C. | 3,177° C. |
| Ni | Nickel | 1,527° C. | 1,907° C. |
| P | Phosphorus | 185° C. | 261° C. |
| Re | Rhenium | 3,067° C. | 3,807° C. |
| Sb | Antimony | 533° C. | 757° C. |
| Si | Silicon | 1,632° C. | 2,057° C. |
| Sn | Tin | 1,247° C. | 1,612° C. |
| Sr | Strontium | 537° C. | 732° C. |
| Ta | Tantalum | 3,057° C. | 3,707° C. |
| TI | Thallium | 609° C. | 827° C. |
| Ti | Titanium | 1,737° C. | 2,177° C. |
| W | Tungsten | 3,227° C. | 3,917° C. |
| Y | Yttrium | 1,632° C. | 2,082° C. |

A variety of amorphous, BMG metal alloys with their Tg, Tx and supercooled liquid region are listed in the following Table (with compositions given at atomic %):

TABLE 1

| Major | | | | | | | |
|---|---|---|---|---|---|---|---|
| element | Alloy Composition | Tg (K) | Tx (K) | Tx − Tg | S | H | Ref. |
| Mg— | Mg80Ni10Nd10 | 454 | 471 | 17 | | | k |
| | Mg75Ni15Nd10 | 450 | 470 | 20 | | | k |
| | Mg60Cu30Y10 | 419 | 466 | 47 | | | c |
| | (Mg99Al1)60Cu30Y10 | 419 | 459 | 40 | | | c |
| | (Mg98Al2)60Cu30Y10 | 421 | 454 | 33 | | | c |
| | (Mg96Al4)60Cu30Y10 | 411 | 455 | 44 | | | c |
| | (Mg95Al5)60Cu30Y10 | 415 | 453 | 38 | | | c |
| | (Mg93Al7)60Cu30Y10 | 411 | 445 | 34 | | | c |
| | Mg70Ni15Nd15 | 467 | 489 | 22 | | | k |
| | Mg65Ni20Nd15 | 459 | 501 | 42 | | | k |
| | Mg65Cu25Y10 | 425 | 479 | 54 | | | k |
| | Mg60Cu30Y10 | 400 | 450 | 50 | | | |
| | Mg65Y10Cu15Ag5Pd5 | 437 | 472 | 35 | 770 | | 1 |
| Zr— | Zr66Al8Ni26 | 672 | 708 | 36 | | | k |
| | Zr66Al8Cu7Ni19 | 662 | 721 | 59 | | | k |
| | Zr66Al8Cu12Ni14 | 655 | 733 | 78 | | | k |
| | Zr66Al9Cu16Ni9 | 657 | 736 | 79 | | | k |
| | Zr65Al7.5Cu17.5Ni10 | 657 | 736 | 79 | | | k |
| | Zr57Ti5Al10Cu20Ni8 | 677 | 720 | 43 | | | k |
| | Zr41.2Ti13.8Cu12.5Ni10Be22.5 | 623 | 672 | 49 | | | k |
| | Zr38.5Ti16.5Ni9.75Cu15.25Be20 | 630 | 678 | 48 | | | k |
| | Zr39.88Ti15.12Ni9.98Cu13.77Be21.25 | 629 | 686 | 57 | | | |
| | Zr42.63Ti12.37Cu11.25Ni10 Be23.75 | 623 | 712 | 89 | | | k |
| | Zr44Ti11Cu10Ni10Be25 | 625 | 739 | 114 | | | k |
| | Zr55Al10Ni5Cu30 | 683 | 748 | 65 | | | d |
| | Zr45.38Ti9.62Cu8.75Ni10Be26.25 | 623 | 740 | 117 | | | |
| | Zr65Al10Ni10Cu15 | 652 | 757 | 105 | | | e |
| | Zr65Al7.5Cu17.5Ni10 | 633 | 749 | 116 | | | i |
| | (Zr65Al7.5Cu17.5Ni10)95Fe5 | 650 | 725 | 75 | | | i |
| | (Zr65Al7.5Cu17.5Ni10)90Fe10 | 670 | 730 | 60 | | | i |
| | (Zr65Al7.5Cu17.5Ni10)85Fe15 | 675 | 735 | 60 | | | i |
| | (Zr65Al7.5Cu17.5Ni10)80Fe20 | 680 | 740 | 60 | | | i |
| | Zr52.5Cu17.9Ni14.6Al10Ti5 | 686 | 725 | 39 | | | j |
| | (Zr67Hf33)52.5Cu117.9Ni14.6Al10Ti5 | 708 | 753 | 45 | | | j |
| | (Zr50Hf50)52.5Cu17.9Ni14.6Al10Ti5 | 722 | 767 | 45 | | | j |
| | (Zr33Hf67)52.5Cu17.9Ni14.6Al10Ti5 | 737 | 786 | 49 | | | j |
| | Zr52.5Cu17.9Ni14.6Al10Ti5 | 767 | 820 | 53 | | | j |
| | Zr52.2Ti16.7Cu17.7Ni8.7B4.7 | 564 | 668 | 104 | | | l |
| | Zr50.2Ti16.7Cu17.7Ni8.7B6.7 | 646 | 719 | 73 | | | l |
| | Zr48.2Ti16.7Cu17.7Ni8.7B8.7 | 682 | 720 | 38 | | | l |
| | Zr54.9Ti16.7Cu17.7Ni8.7P2.0 | 578 | 686 | 108 | | | l |
| | Zr53.9Ti16.7Cu17.7Ni8.7P3.0 | 636 | 722 | 86 | | | l |
| | Zr52.9Ti16.7Cu17.7Ni8.7P4.0 | 698 | 734 | 36 | | | l |
| | Zr54.9Ti16.7Cu17.7Ni8.7Si2.0 | 562 | 681 | 119 | | | l |
| | Zr53.9Ti16.7Cu17.7Ni8.7Si3.0 | 563 | 681 | 118 | | | l |
| | Zr52.9Ti16.7Cu17.7Ni8.7Si4.0 | 639 | 742 | 103 | | | l |
| | Zr41.2Ti13.8Cu12.5Ni10Be22.5 | 633 | 741 | 108 | | | l |
| | Zr70Fe20Ni10 | 646 | 673 | 27 | | | o |
| | Zr60Al10Cu30 | 680 | 750 | 70 | | | p |
| | Zr65Al7.5AlCu1017.5 | 625 | 750 | 125 | | | z |
| | Zr70Ni23Ti7 | | | 30 | | | 2 |
| | Zr65Al10Cu15Ni10 | | | 95 | | | 3 |
| La— | La55Al25Ni10Cu10 | 467 | 547 | 80 | | | k |
| | La55Al25Ni5Cu15 | 459 | 520 | 61 | | | k |
| | La55Al25Cu20 | 456 | 495 | 39 | | | k |
| | La55Al25Ni5Cu10Co5 | 465 | 542 | 77 | | | k |
| | La66Al14Cu20 | 395 | 449 | 54 | | | k |
| | La60Al20Ni10Co5Cu5 | 451 | 523 | 72 | | | g |
| Pd— | Pd40Cu30Ni10P20 | 577 | 656 | 79 | | | k |
| | Pd81.5Cu2Si16.5 | 633 | 670 | 37 | | | k |
| | Pd79.5Cu4Si16.5 | 635 | 675 | 40 | | | k |
| | Pd77.5Cu6Si16.5 | 637 | 678 | 41 | | | k |
| | Pd77Cu6Si17 | 642 | 686 | 44 | | | k |
| | Pd73.5Cu10Si16.5 | 645 | 685 | 40 | | | k |
| | Pd71.5Cu12Si16.5 | 652 | 680 | 28 | | | k |
| | Pd40Ni40P20 | 590 | 671 | 80 | | | k |
| Nd— | Nd60Al15Ni10Cu10Fe5 | 430 | 475 | 45 | | | k |
| | Nd61Al11Ni8Co5Cu15 | 445 | 469 | 24 | | | k |
| Cu— | Cu60Zr30Ti10 | 713 | 763 | 50 | | | k |
| | Cu54Zr27Ti9Be10 | 720 | 762 | 42 | | | k |
| | Cu48Ti34Zr10Ni8 | — | — | — | | | |
| | Cu47Ti34Zr11Ni8 | 688 | 743 | 55 | | | 4 |
| | (Cu60Zr30Ti10)99Sn1 | | | | | | 5 |
| Ti— | Ti34Zr11Cu47Ni8 | 698 | 727 | 29 | | | k |
| | Ti50Ni24Cu20B1Si2Sn3 | 726 | 800 | 74 | | | h |
| | Ti45Ni20Cu25Sn5Zr5 | | | | | | |
| | Ti50Cu25Ni25 | 713 | 753 | 40 | | | m |
| | Ti50Ni22Cu25Sn3 | 715 | 765 | 50 | | | m |
| | Ti50Ni20Cu25Sn5 | 710 | 770 | 60 | | | m |
| | Ti50 Ni20Cu23Sn7 | 710 | 759 | 49 | | | m |
| | Ti50Ni24Cu25Sb1 | 707 | 740 | 33 | | | m |
| | Ti50Ni22Cu25Sb3 | 763 ?? | 718 | 45 | | | m |
| | Ti50Cu35Ni12Sn3 | — | — | — | | | |
| | Ti74Ni20Si4B2 | 700 | 752 | 52 | | | 6 |
| | T64Ni30Si4B2 | 700 | 774 | 74 | | | [symbol] |
| | Ti64Cu10Ni20Si4B2 | 700 | 758 | 58 | | | [symbol] |
| | Ti74Cu10Ni10Si4B2 | 700 | 761 | 61 | | | [symbol] |
| | Ti50Ni20Cu25Sn5 | 710 | 770 | 60 | | | Z |
| | Ti50Ni24Cu20Si4B2 | 735 | 800 | 65 | | | Z |
| | Ti—Cu—Ni—B—Sn—Si | | | >70 | 2100 | 620 | 7 |
| | Ti50Cu20Ni24Si4B2 | 742 | | | | | 8 |
| Fe— | Fe63Ni7Zr10B20 | 553 | 579 | 26 | | | b |
| and/or | Fe56Ni14Zr10B20 | 579 | 601 | 22 | | | b |
| Co— | Fe49Ni21Zr10B20 | 589 | 611 | 22 | | | b |
| | Fe42Ni28Zr10B20 | 602 | 619 | 18 | | | b |
| | Fe42Co7Ni21Zr10B20 | 580 | 611 | 30 | | | b |
| | Fe72Hf8Nb2B18 | 856 | 932 | 76 | | | f |
| | (Fe, Co)85 Zr7B6(Nb, Nd)2 | | | | | | |
| | Fe 74.5Si13.5B9Nb3 | | | | | | |
| | Fe58Co7Ni7Zr8B20 | 821 | 899 | 78 | | | n |
| | Fe52Co10Nb8B30 | 907 | 994 | 87 | | | n |
| | Fe62Co9.5RE3.5B25 (RE = Pr, Nd, Sm, Gd, Tb, Dy, Er) | | | >50 | | | |
| | (22.5-30 at % B, 0-30 at % Co and 2.5-6 at % RE) | | | | | | |
| | Co63Fe7Zr6Ta4B20 | 858 | 895 | 37 | | | n |
| | Co40Fe22Nb8B30 | 895 | 976 | 81 | | | n |
| | Co43Fe20Ta5.5B31.5 | 910 | 980 | | | | 9 |
| | Fe75-x-yCoxNiySi8B17 (7.5-45% Co and 7.5-60% Ni) | | | Up to 54 | | | s |
| | Fe30Co30Ni15Si8B17 | 780 | 834 | 54 | 2800 | | 10 |
| | Fe90-xNb10Bx | — | — | — | | | t |
| | Fe85.5Zr2Nb4B8.5 | — | — | — | | | |
| | Fe70B20Zr8Nb2 | | | 91 | | | u |
| | Fe62Co6Zr6Nb4Cr2B20 | | | 85 | | | 11 |
| | Fe63Co7Nb4Zr6B20 | | | 79 | | | 12 |
| | (Fe0.75B0.15Si0.1)99Zr1 | 815 | 867 | 52 | | | 13 |
| | Fe—Cr—Mo—C—B—P | | | 90 | | | 14 |
| | Fe75Ga5P12C4B4 | 761 | 768 | 37 | | | 15 |
| | Fe70Al5Ga2P9.65 C5.75B4.6Si3 | | | 60 | | | 16 |
| | Fe66.5Co10Nd3.5B20 | | | 40 | | | 17 |
| | Fe75Ga5P12C4B4 | 731 | 768 | 37 | | | 18 |
| | Fe47Co30Sm3B20 | | | 41 | | | 19 |
| | Fe66.5Co10Nd3.5B20 | 802 | 842 | 40 | | | 20 |
| | Fe70Al5Ga2P9.65C5.75B4.6Si3 | | | 60 | | | 21 |
| | Fe—Co—Ni—Hf—B | | | 80+ | | | 22 |
| | (Fe70Mn20Cr10)68Zr7Nb3B22 | 595 | | 75 | 3000+ | | 23 |
| | (Fe69Mn26Cr5)68Zr10C3B19 | 580 | | 70 | 3000+ | | Poon 3 |
| | (Fe69Mn26Cr5)70Zr4Nb4B22 | 595 | | 78 | 3000+ | | Poon 3 |
| | (Fe69Mn26Cr5)68Zr4Nb4B24 | 613 | | 85 | 3000+ | | Poon 3 |
| | (Fe66Mn29Mo5)68Zr4Nb4B24 | 605 | | 87 | 3000+ | | Poon 3 |
| | (Fe66Mn29Cr5)68Zr4Nb4B24 | 600 | | 100 | 3000+ | | Poon 3 |
| | (Fe69Mn26Cr5)68Zr4Ti4B24 | 560 | | 60 | 3000+ | | Poon 3 |
| | (Fe66Mn29Mo5)68Zr4Nb4B22Si2 | ˜595 | | 75 | 3000+ | | Poon 3 |
| | (Fe60Mn25Cr5Ni10)68Zr7Nb3B22 | 572 | | 75 | 3000+ | | Poon 3 |
| Al— | Al85Ni5Y8Co2 | 538 | 570 | 32 | | | a |
| | Al87(La,Nd,Pr)8Ni5 | 500 | 553 | 53 | | | r |
| | Al92(La,Nd,Pr)4Ni4 | 525 | 608 | 83 | | | r |
| | Al—Ti—M (M = V, Fe, Co and/or Ni) alloys, such as | | | | | | v |
| | Al94V4Fe2, Al93Ti4Fe3, Al93Ti4V3 | | | | | | |
| | Al94V2Ti2Fe2 | | | | | | |
| | Al93Ti5Fe2 | | | | | | |
| | Ta55Zr10Ni10Al10Cu15 | 834 | 1004 | 170 | | | 24 |
| | Ni76Ti5P19 | 659 | 707 | 48 | | | z |
| | Ni65Nb5Cr5Mo5P14B6 | 701 | 762 | 61 | | | z |
| | Ni57Zr20Ti18Al5 | 800 | 841 | 41 | | | z |
| | Ni60Nb20Ti12.5Hf7.5 | | | 60 | 3180 | | 25 |
| | Ni—Nb—Sn—X (X = B, Fe, Cu) | 881-895 | | 40-60 | 3-3800 | 1000-1280 | 26 |
| | Ni57Zr20Ti20Si3 | | | | 788-830 | 88 | 27 |
| | Ni65Nb5Cr5Mo5P14-16B4-6 | 703 | 753 | 50 | 2690 | 840 | 28 |
| | Cu40Zr30Ti30 | | | 61 | | | 29 |
| | Cu40Ti30Ni15Zr10Sn5 | 735 | 780 | 45 | | | 30 |
| | La55Al25Ni20 | 483 | | 65 | | | 31 |

a. Kawamura, Y., et al., “Nanocrystalline Aluminum Bulk Alloys with a High Strength of 1420 MPa Produced by the Consolidation of Amorphous Powders”, Scripta mater., 44; 1599-1604 (2001)
b. Liu, Y. J., et al., “The correlation of microstructural development and thermal stability of mechanically alloyed multicomponent Fe—Co—Ni—Zr—B alloys”, Acta Materialia, 50, 2747-2760 (2002)
c. Linderoth, S., et al., “On the stability and crystallization of bulk amorphous Mg—Cu—Y—Al Alloys”, Materials Science and Engineering A304-306, 656-659 (2001)
d. deOliveira, M. F., et al., “Effect of oxide particles on the crystallization behaviour of Zr₅₅Al₁₀Ni₅Cu3₀ Alloy”, Materials Science & Engineering A304-306, 665-6659 (2001)
e. Kawamura, Y., et al., “Newtonian and non-Newtonian viscosity of supercooled liquid in metallic glasses”, Materials Science & Engineering, A304-306, 674-678 (2001)
f. Kawamura, Y., et al., “Superplasticity in Fe-based metallic glass with wide supercooled liquid region”, Materials Science & Engineering, A304-306, 674-678 (2001)
g. Saotome, Y., et al., “Superplastic micro/nano formability of La₆₀Al₂₀Ni₁₀Co₅Cu5 amorphous alloy in supercooled liquid state”, Materials Science & Engineering, A304-306, 716-720 (2001)
h. Zhang, T., et al., “Ti-based amorphous alloys with a large supercooled liquid region”, Materials Science & Engineering, A304-306, 771-774 (2001)
i. Mattern, N., et al., “Influence of iron additions on structure and properties of amorphous Zr₆₅Al_{7.5}Cu_{17.5}Ni₁₀”, Materials Science and Engineering A304-306, 311-314 (2001)
j. Glass-forming ability and crystallization of bulk metallic glass (HfxZr1-x)52.5Cu17.9Ni14.6Al10Ti5”, Journal of Non-Crystalline Solids”, 311 77-82 (2002)
k. Lu, Z. P., et al., “A new glass-forming ability criterion for bulk metallic glasses”, Acta Materialia, 50, 3501-3512 (2002)
l. Choi, et al., “Effect of Additive Elements on the Glass Forming Ability and Crystallization of Zr—Ti—Cu—Ni Metallic Glasses”, Journal of Metastable and Nanocrystalline Materials, Vols. 343-346, pp. 109-115 (2000)
m. Inoue, A., “Synthesis and Properties of Ti-Based Bulk Amorphous Alloys with a Large Supercooled Liquid Region”, Journal of Metastable and Nanocrystalline Materials, Vols. 2-6 (1999), pp. 307-314
n. Inoue, et al., “Ferromagnetic Bulk Glassy Alloys with Useful Engineering Properties”, Journal of Metastable and Nanocrystalline Materials, Vols. 343-346, pp. 81-90 (2000)
o. Saida, et al., “Nano-Icosahedral Quasicrystalline Phase Formation from a Supercooled Liquid State in Zr—Fe Ternary Metallic Glass”, Applied Physics Letters, Vol. 76, No. 21, pp. 3037-3039 (May 22, 2000)
p. Inoue, et al., “Synthesis of High Strength Bulk Nanocrystalline Alloys Containing Remaining Amorphous Phase”, Journal of Metastable and Nanocrystalline Materials, Vol. 1, pp. 1-8 (1999)
q. Eckert, J., “Mechanical Alloying of Highly Processable Glassy Alloys”, Materials Science and Engineering, A226-228, pp. 364-373 (1997)
r. Tong, et al., “Microstructure and Thermal Analysis of Amorphous Al87RE8Ni5 and AL92RE4Ni4 Alloys”, Materials Letters, Vol. 28, pp. 133-136 (1996)
s. Zhang et al, “Bulk glassy alloys in (Fe, Co, Ni)—Si—B system”, Materials Transactions, v 42, (2001)
t. Imafuku et al, “Structural variation of Fe—Nb—B metallic glasses during crystallization process”, Scripta Materialia, v 44 (2001)
u. Ma et al, “Fe-based metallic glass with significant supercooled liquid region of over 90 K”, Journal of Materials Science Letters, v 17 (1998)
v. Kimura et al, “Formation of nanogranular amorphous phase in rapidly solidified Al—Ti—M (M = V, Fe, Co or Ni) alloys and their mechanical strength”, Nanostructured Materials, v 8, p 833-844 (1997)

While this table lists certain primarily BMG alloys, other amorphous alloys may also be used. The amorphous metal powder blend may also include other components such as reinforcing and/or alloying fibers or powders. Such fibers or powders may be densely consolidated within the condensed and solidified amorphous alloy layer(s) deposited on the substrate.

If it is desired to include “intact” powders and/or (short) fibers, these components should best be substantially larger than the approximately 10 million or less metal/metallized powders which are intended to be vaporized. For example, amorphous metal alloy powders of the same or similar composition to the alloy being deposited from the vapor, but a diameter of, for example, about 45 to about 150 microns, may be introduced in to the plasma gun nozzle to be applied to the substrate with the condensing alloy vapor. Amorphous alloy powders to be co-deposited on the substrate, as “splats” with the condensing alloy vapor should be fully melted in the plasma before implact on the substrate, and then rapidly cooled on the substrate before crystallization, if it is desired to maintain the amorphous characteristic of the “splats”.

In such processes, the mass ratio of the vaporized small-particle alloy component to the relative large particle size component should be at least about 0.25 to 1.00, and preferably, at least about 0.5 to 1.0.

It should be noted that even for larger 45-150 micron particles, some of the surface of these particles may be vaporized in the plasma gun plume as they are heated to a temperature about the melting point. As shown in the preceding table, different elements of these surface components may have significantly different vaporization rates, which will change the composition of the molten particles.

For example, magnesium and aluminum have relatively high vaporization rates in an ultrahot plasma plume, while iron and boron have relatively slower vaporization rates. However, in accordance with the present method, such differential vaporization (and condensation rate) may be compensated for by controlling the composition of the vapor phase to include an excess of the higher-volatility components.

As indicated, many BMG alloys with a broad supercooled liquid region may be vaporized for deposition in accordance with the present disclosure. However, aluminum-based alloys tend to have marginal glass-forming ability, and do not readily form BMG alloys with a wide supercooled liquid range. A few Al-based alloys have small supercooled liquid regions (such as Al85Y8Ni5Co2 Tx-Tg˜30° K.), which have been spray formed with some degree of amorphous phase retention, but most amorphous aluminum alloys have no Tg, and progressively crystallize with increasing temperature.

TABLE 2

| Conventional Al-based | | | |
|---|---|---|---|
| Alloy Amorphous | | New Al-based Alloy with (Ca,Ba)-Si2 | New Al-based Alloy with (Zr, Ti)-(B,Si) |
| At % | Ref. | Backbone At % | Backbone At % |
| Al73Cu16Ni5Mg8 | 32 | (Al73Cu16Ni5Mg8)70(Ca,Ba)10Si20 | (Al73Cu16Ni5Mg8)70(Zr,Ti)10(B,Si)i20 |
| Al93Ti4Fe3 | 33 | (Al93Ti4Fe3)70(Ca,Ba)10Si20 | (Al93Ti4Fe3)70(Zr,Ti)10(B.Si)20 |
| Al90Fe7Nb3 | 34 | (Al90Fe7Nb3)70(Ca,Ba)10Si20 | (Al90Fe7Nb3)70(Zr,Ti)10(B.Si)20 |
| Al-4Ni-6Ce | 35 | (Al-4Ni-6Ce)70(Ca,Ba)10Si20 | (Al-4Ni-6Ce)70(Zr,Ti)10(B.Si)20 |
| Al85Ni5Y4Mm4Co2 | 36 | (Al85Ni5Y4Mm4Co2)70(Ca,Ba)10Si20 | (Al85Ni5Y4Mm4Co2)70(Zr,Ti)10(B.Si)20 |
| Al85Y8Ni5Co2. | | (Al85Y8Ni5Co2)70(Ca,Ba)10Si20 | (Al85Y8Ni5Co2)70(Zr,Ti)10(B.Si)20 |
| Al84Ni8Co4Y3Zr1 | 37 | (Al84Ni8Co4Y3Zr1)70(Ca,Ba)10Si20 | (Al84Ni8Co4Y3Zr1)70(Zr,Ti)10(B.Si)20 |
| Al75Ni21Y4 | 38 | (Al75Ni21Y4)70(Ca,Ba)10Si20 | (Al75Ni21Y4)70(Zr,Ti)10(B.Si)20 |
| Al90Fe5Ce5 | 39 | (Al90Fe5Ce5)70(Ca,Ba)10Si20 | (Al90Fe5Ce5)70(Zr,Ti)10(B.Si)20 |
| Al84Ni5Y9Co2 | 40 | (Al84Ni5Y9Co2)70(Ca,Ba)10Si20 | (Al84Ni5Y9Co2)70(Zr,Ti)10(B.Si)20 |
| Al92V3Fe3Zr2 | 41 | (Al92V3Fe3Zr2)70(Ca,Ba)10Si20 | (Al92V3Fe3Zr2)70(Zr,Ti)10(B.Si)20 |
| Al93Fe3Ti2V2 | 42 | (Al93Fe3Ti2V2)70(Ca,Ba)10Si20 | (Al93Fe3Ti2V2)70(Zr,Ti)10(B.Si)20 |
| Al93Fe3Ti2Cr2 | | (Al93Fe3Ti2Cr2)70(Ca,Ba)10Si20 | (Al93Fe3Ti2Cr2)70(Zr,Ti)10(B.Si)20 |
| Al94.5Cr3Co1.5Ce1 | 43 | (Al94.5Cr3Co1.5Ce1)70(Ca,Ba)10Si20 | (Al94.5Cr3Co1.5Ce1)70(Zr,Ti)10(B.Si)20 |
| Al86V14 | 44 | (Al86V14)70(Ca,Ba)10Si20 | (Al86V14)70(Zr,Ti)10(B.Si)20 |
| Al84.6Cr15.4 | | (Al84.6Cr15.4)70(Ca,Ba)10Si20 | (Al84.6Cr15.4)70(Zr,Ti)10(B.Si)20 |
| Al77.5Mn22.5 | | (Al77.5Mn22.5)70(Ca,Ba)10Si20 | (Al77.5Mn22.5)70(Zr,Ti)10(B.Si)20 |
| Al94Cr5Ce1Al93Ti4Fe3 | | (Al94Cr5Ce1Al93Ti4Fe3)70(Ca,Ba)10Si20 | (Al94Cr5Ce1Al93Ti4Fe3)70(Zr,Ti)10(B.Si)20 |
| Al90Fe5Nd5 | 45 | (Al90Fe5Nd5)70(Ca,Ba)10Si20 | (Al90Fe5Nd5)70(Zr,Ti)10(B.Si)20 |
| Al56Si30Fe10Cr4 | 46 | (Al56Si30Fe10Cr4)70(Ca,Ba)10Si20 | (Al56Si30Fe10Cr4)70(Zr,Ti)10(B.Si)20 |
| Al44Si30Ge12Fe10Cr4 | | (Al44Si30Ge12Fe10Cr4)70(Ca,Ba)10Si20 | (Al44Si30Ge12Fe10Cr4)70(Zr,Ti)10(B.Si)20 |
| Al89Fe10Zr1 | 47 | (Al89Fe10Zr1)70(Ca,Ba)10Si20 | (Al89Fe10Zr1)70(Zr,Ti)10(B.Si)20 |
| Al90Ti10 | 48 | (Al90Ti10)70(Ca,Ba)10Si20 | (Al90Ti10)70(Zr,Ti)10(B.Si)20 |
| Al87Ni10Ce3 | 49 | (Al87Ni10Ce3)70(Ca,Ba)10Si20 | (Al87Ni10Ce3)70(Zr,Ti)10(B.Si)20 |
| Al87Ni10Zr3 | | (Al87Ni10Zr3)70(Ca,Ba)10Si20 | (Al87Ni10Zr3)70(Zr,Ti)10(B.Si)20 |
| Al87Ni7Cu3Ce3 | | (Al87Ni7Cu3Ce370(Ca,Ba)10Si20 | (Al87Ni7Cu3Ce370(Zr,Ti)10(B.Si)20 |
| Al94V4Fe2 | 50 | (Al94V4Fe2)70(Ca,Ba)10Si20 | (Al94V4Fe2)70(Zr,Ti)10(B.Si)20 |
| Al94V2Ti2Fe2 | | (Al94V2Ti2Fe2)70(Ca,Ba)10Si20 | (Al94V2Ti2Fe2)70(Zr,Ti)10(B.Si)20 |
| Al94V2Ti2Fe2 | | (Al94V2Ti2Fe2)70(Ca,Ba)10Si20 | (Al94V2Ti2Fe2)70(Zr,Ti)10(B.Si)20 |
| Al94.5Cr3Ce1Co1.5 | 51 | (Al94.5Cr3Ce1Co1.5)70(Ca,Ba)10Si20 | (Al94.5Cr3Ce1Co1.5)70(Zr,Ti)10(B.Si)20 |
| Al96.7Cr3Mo0.3 | 52 | (Al96.7Cr3Mo0.3)70(Ca,Ba)10Si20 | (Al96.7Cr3Mo0.3)70(Zr,Ti)10(B.Si)20 |
| Al93.1Ti2.5Fe2.3Cr2.3 | 53 | (Al93.1Ti2.5Fe2.3Cr2.3)70(Ca,Ba)10Si20 | (Al93.1Ti2.5Fe2.3Cr2.3)70(Zr,Ti)10(B.Si)20 |
| Si45Al31Fe20Ni4 | 54 | (Si45Al31Fe20Ni4)90(Ca,Ba)10 | (Si45Al31Fe20Ni4)80 Zr5B10 |
| Si45Al36Fe15Ni4 | | (Si45Al36Fe15Ni4)90(Ca,Ba)10 | (Si45Al36Fe15Ni4)80 Zr5B10 |
| Si45Al41Fe10Co4 | | (Si45Al41Fe10Co4)90(Ca,Ba)10 | (Si45Al41Fe10Co4)80 Zr5B10 |
| Si55-45Al20Fe10Ni5Cr | 55 | (Si55-45Al20Fe10Ni5Cr)90(Ca,Ba)10 | (Si55-45Al20Fe10Ni5Cr)80 Zr5B10 |
| 5Zr5Ge0-10 | | (5Zr5Ge0-10)90(Ca,Ba)10 | (5Zr5Ge0-10)80 Zr5B10 |
| Si55Al20Fe10Ni5Cr5Zr5 | 56 | (Si55Al20Fe10Ni5Cr5Zr5)90(Ca,Ba)10 | (Si55Al20Fe10Ni5Cr5Zr5)80 Zr5B10 |
| Si45Al31Fe20Ni4 | 57 | (Si45Al31Fe20Ni4)90(Ca,Ba)10 | (Si45Al31Fe20Ni4)80 Zr5B10 |
| Si45Al36Fe15Ni4 | | (Si45Al36Fe15Ni4)90(Ca,Ba)10 | (Si45Al36Fe15Ni4)80 Zr5B10 |
| Si45Al41Fe10Co4 | | (Si45Al41Fe10Co4)90(Ca,Ba)10 | (Si45Al41Fe10Co4)80 Zr5B10 |
| Si55Al20Fe10Ni5Cr5Zr5 | 58 | (Si55Al20Fe10Ni5Cr5Zr5)90(Ca,Ba)10 | (Si55Al20Fe10Ni5Cr5Zr5)80 Zr5B10 |
| Si50Al25Fe10Ni5Cr5Zr5 | | (Si50Al25Fe10Ni5Cr5Zr5)90(Ca,Ba)10 | (Si50Al25Fe10Ni5Cr5Zr5)80 Zr5B10 |

Accordingly, new aluminum-based amorphous alloys with improved amorphous properties are desirable, and are also described in accordance with the present disclosure. The new Al-based amorphous alloys are MSL class alloys with midsize atoms “M” as the majority component (60-70 at. %), small atoms “S” as the next-majority component (20-30 at %), and large-size atoms “L” as the minority component (10 at. %). The “L/S” pairs have high negative heats of mixing to stabilize the glass.

The aluminum alloys based on aluminum as the midsize component and (Ca, Ba)—Si and/or (Zr,Ti)—B as the L/S pairs. In the proposed MSL alloys, the negative heats of mixing are large for enhancement of the stability of the undercooled melt. The concentration of the L atoms is from 3-12, preferably about 10 at. %, and the “S” atom content is about 20-30 at. %. Smaller amounts, however, can still improve the glass-forming-ability (GFA) properties of Al-based alloys.

The first L/S pair relies on Calcium, Strontium and/or Barium as the inexpensive “large” atom, and Silicon as the “small” atom component. The Ca—Si2 pair has a large negative heat of mixing, as does the Ca—Al interaction with the base Aluminum “M” component. Moreover, Al and Si are fully compatible in amorphous compositions, and also have a large negative heat of mixing. Calcium is a relatively large atom, and very light, and Ba and Sr are even larger, while still having reasonably low density. The atomic size ratio of Ca/Al is 1.37, as shown in the following Table 3.

TABLE 3

| | Atomic | Density |
|---|---|---|
| Element | Size nm | gm/cm3 |
| B | 0.098 | 2.34 |
| Ni | 0.124 | 8.9 |
| Co | 0.125 | 8.9 |
| Fe | 0.126 | 7.86 |
| Cu | 0.128 | 8.96 |
| Cr | 0.130 | 7.19 |
| Si | 0.132 | 2.33 |
| V | 0.134 | 5.8 |
| Mn | 0.135 | 7.43 |
| Al | 0.143 | 2.7 |
| Ti | 0.145 | 4.5 |
| Mg | 0.160 | 1.74 |
| Zr | 0.161 | 6.49 |
| Y | 0.178 | 4.5 |
| Nd | 0.182 | 7 |
| Ca | 0.197 | 1.55 |
| Sr | 0.215 | 2.6 |
| Ba | 0.222 | 3.5 |

Al—Ca binary alloys (and mixtures with Mg, Zn, Fe, Ga, Ni and Cu additions) can be amorphized in the composition range of 9 to 11 at % Ca by melt spinning.⁵⁹ Amorphous Mg70Al20Ca10 alloys with density of 1.80 g/cm3 can have a yield strength up to 930 MPa and a plastic strain up to 9.2%⁶⁰, which is almost twice as strong as Beryllium, at approximately the same weight. New Al-based compositions in which (Ca,Ba)—Si are added to known amorphous aluminum alloys in accordance with the present disclosure, are listed in the middle column of Table 1, above. The multinary nature of most of these compositions is favorable to amorphous property development, as most pairs have large mixing heats, and a smoother size progression is provided than with a smaller number of elements.

The second L/S pair for use in MSL Aluminum-based BMG alloys disclosed herein relies on Zr and/or Zr—Ti, Hf blends as the large atom component, and Boron and/or Silicon as the small atom component. Zr—B pair has a very large negative heat of mixing, and B and Si are both compatible with amorphous Al-alloys. The density of Zr is not prohibitive for lightweight alloys in minor amounts, and the atomic size ratio of Zr/Al is large enough at 1.13 to facilitate BMG formation.

Al-based compositions in which (Zr,Ti)—B are combined with known amorphous aluminum alloys in accordance with the present disclosure are listed in the middle column of Table 1, above. In both the Ca,Ba compositions, and the Zr,Ti compositions, a mixture of B and Si can be beneficial in fostering larger-cluster formation, thereby increasing viscosity and reducing diffusion of Al and smaller atoms.

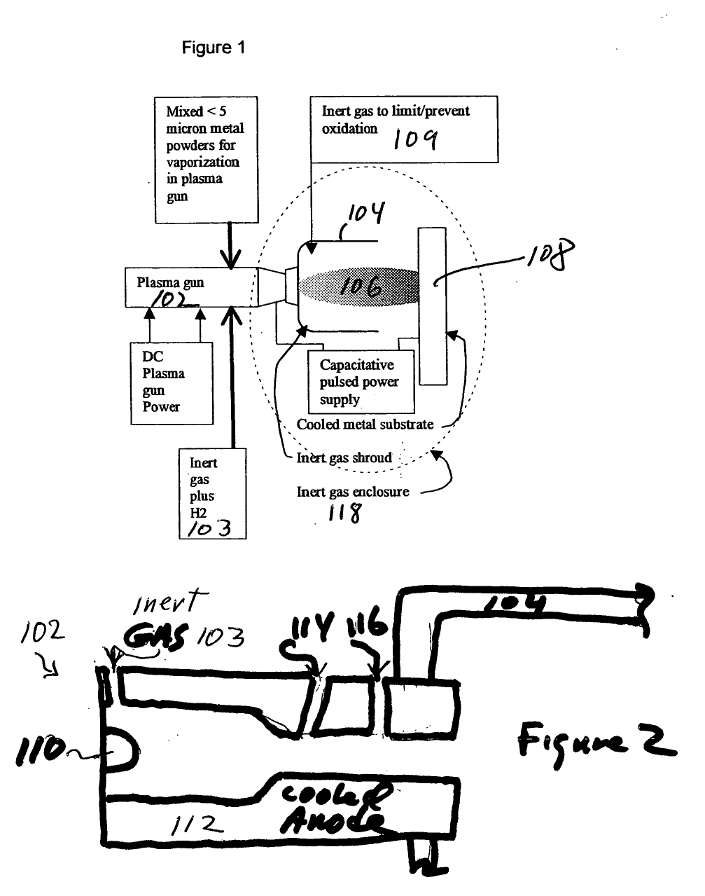

In the apparatus of FIG. 1, small metal/metalloid particles are vaporized in a hot plasma. Preferably, the particles have a uniform bulk metal glass composition. However, powder blends of different alloy components may also be used. The metal/metalloid vapor is condensed on a suitable metal substrate to form an intimate bond with the substrate. Preferably, the substrate is cooled to enhance the solidification of the deposited vapor, and keep the surface below the glass transition temperature of the amorphous metal vapor composition being condensed on the surface. Conventional, larger (˜25-100 micron) metal thermal spray particles can be included, which may have an enhanced bond in the coating because of the condensing vapor. A reducing plasma can be used to keep the metal substrate clean and even help reduce a thin oxide surface layer to assist formation of a good, preferably metallurgical, bond. By forming appropriate vapor compositions, the vapor-condensed layer can be an amorphous metal composition, and preferably a bulk metal glass composition. The condensed-deposited amorphous (including partially nano-crystallized) layer can be retained as is, or can subsequently be treated to further crystallize or nanocrystallize it, to obtain specific properties, such as increased hardness.

The illustrated apparatus 100 comprises a conventional plasma gun 102, and a conventional inert gas shield 104. As shown in FIG. 1, the plasma gun 102 produces an ultrahigh temperature plasma plume 106 which is directed toward a suitable substrate 108, such as cooled steel, stainless steel, aluminum or titanium alloy substrate.

As shown in the cross-sectional view of FIG. 2, the plasma gun 102 has an axially aligned cathode 110, typically of a refractory metal with a low work function such as tungsten or thoriated tungsten, and a water cooled anode 112 through which powdered metals to be vaporized and deposited on the substrate 108 may be introduced through appropriate passageways 114, 116. If desired, the thermal spray apparatus 100 (FIG. 1) may be enclosed in a controlled-atmosphere chamber or vacuum chamber 118 if it is desired to exclude reactive gas such as oxygen or nitrogen, and/or to operate in subatmospheric pressure. In operation, an inert gas such as an argon-helium mixture 103, which may include a small amount of hydrogen, is introduced into the plasma gun 102, while direct-current is applied from a suitable power source to the cathode and anode of the gun to heat the inert gas to a temperature of 10-30 thousand degrees Kelvin to form a high-velocity plasma plume 106. A selected amorphous metal alloy, which is preferentially a bulk metal glass alloy, having a largest dimension of about five microns or less, is introduced into the plasma gun 102 through conventional introduction port 114, with an inert gas and/or hydrogen. The more volatile elements such as magnesium, boron and aluminum can be in relatively larger particles, while refractory elements such as Zr are heat volatilized from a smaller particle form. The metal powder may be a homogenous alloy of the specific alloy which is desired to be deposited on the substrate 108, or may be a mixture of alloy powders or elemental metals which are proportioned to form the desired alloy upon vaporization and deposition. Because of their small size, and the intensity of the plasma thermal spray operation, the metal powder is substantially fully vaporized in the plasma plume 106. In operation, a shielding gas 109 such as argon or helium may be introduced into the zone 104 surrounding the plasma plume 106, in order to protect the metal components of the plasma plume from external reactive atmosphere components such as oxygen and nitrogen. Preferably, however, the entire thermal spray process is carried out in a controlled atmosphere or vacuum zone 118, in which reactive gases such as oxygen and nitrogen are substantially excluded.

As indicated, the amorphous metal coating is deposited on the selected substrate 108. In this regard, it is important that the substrate be maintained at a temperature below the glass transition temperature or the crystallization temperature of the amorphous metal composition which is being deposited. Preferably, the substrate will be maintained at a temperature of at least 25 degrees Kelvin, and preferably at least 100 degrees Kelvin below the half crystallization temperature of the amorphous metal composition being applied thereto.

In order to facilitate the formation of a strong, metallurgical bond between the metallic substrate 108 and the amorphous metal layer being deposited on the substrate, a pulsed power supply 120 may be provided in electrical contact with the plasma gun anode 112 and the substrate 108. While a continuous current, which is a substantial fraction of that between the cathode 110 in the anode 112, could tend to heat the surface of the metal substrate in deposited layer, a short duty-cycle discharge as optionally provided in accordance with the present methods can be utilized to enhance surface bonding, while limiting surface heat generation.

In this regard, a capacitively-pulsed power supply, with a capacitance of 100,000 microfarads is charged to a DC voltage of 100-220 volts, and in connection with its positive (cathodic) voltage terminal to the substrate and its negative (anodic) voltage terminal to the cooled metal anode 112 of the plasma gun 102. The pulsed power supply is periodically discharged at a rate of above once per second and a duty cycle of about 0.1 to 1 percent (1 to 10-milliseconds per pulse) during the initial pass of the amorphous metal vapor phase over the substrate, to enhance the bond with the substrate by removing any oxide surface layer. By a cathodic pulse to its electrically-conducting substrate 108, cations from the plasma plume 106 are accelerated to impact and clean the substrate surface. In addition, the substrate tends to be “cooled” by the evaporation of electrons compared to being heated by their impact if connected to the anode.

### EXAMPLE 1

An iron-based BMG having a composition of (Fe66Mn29Cr5)68Zr4Nb4B24 (atomic percent) is vaporized in the plasma gun 102, and condensed and solidified on a steel substrate 108 which is actively cooled to −10° C. by a glycol cooling stream and refrigeration unit. The feed rate of the alloy powder having a particle size of less than 3 microns is 1 pound per hour with 5-10 scfh of argon 103. Argon is fed to the plasma spray gun 102 at a rate of about 75 scfh, and DC power is fed to the plasma spray gun to produce a plasma temperature of over 20,000° K. The vapor plasma plume is moved along the substrate at a rate of about 2 meters/second at a distance from the end of the gun to the substrate of 5-15 cm. The deposition is carried out in a vacuum in the chamber of approximately 0.01 to 0.1 atmosphere. A slight excess (e.g., 5 atom percent) of the more volatile boron component may be included in the small diameter powder, to produce the desired BMG stoichiometry in the condensed vapor deposit on the substrate. This may be determined empirically. The alloy vapor condenses on the substrate and rapidly solidifies to form a BMG coating of substantially full density with good adherence to the substrate.

### EXAMPLE 2

In this example, an aluminum-based alloy from Table 2 having a composition of (Al85Y8Ni5Co2)70Ba8Ca210Si20 or (Al85Y8Ni5Co2)70(Zr,Ti)10B18Si2 (atomic percent) is applied to a cooled, clean copper sheet as described in Example 1, with a similar result. Excess Ca and Al may be used in the input powders, as empirically determined, to obtain the desired atomic ratio in the deposit.

### EXAMPLE 3

In this example, a copper-based BMG having a composition Cu40Ti30Ni15Zr10Sn5 (atomic percent) is applied to a cooled copper sheet as described in Example 1, with a similar result

### EXAMPLE 4

In this example, a nickel-based BMG having the composition Ni60Nb20Ti12.5Hf7.5 is applied to a rotating, cooled steel mandrel, as generally described in Example 1, with a similar result.

### EXAMPLE 5

In this example, a zirconium-based BMG alloy, Zr65Al7.5Ni10Cu17.5 is applied to a cooled steel alloy substrate as in Example 1. Excess aluminum may be vaporized, as indicated, to achieve the desired deposit ratios.

### EXAMPLE 6

In this example, a titanium-based amorphous alloy, Ti50Ni24Cu20B1Si2Sn3 (atomic percent, is applied to a cooled, aluminum 2519-T87 or TiAl6V4 alloy sheet.

### EXAMPLE 7

In a series of test runs, aluminum, magnesium and boron powders of diameters less than 10 microns are introduced in to the apparatus of FIGS. 1 and 2 as generally described in Example 1, in proportions to deposit an ultra hard composition ranging from AlMgB₁₀to AlMgB₂₄ on a titanium alloy substrate maintained at 200° C. The deposits are dense, and substantially amorphous and adherent on the substrate. Deposits of nominal composition AlMgB₁₄ (atomic percent) are heated to 1100° C. in a vacuum to crystallize the composition to form an ultra hard material.

Up to 30 atomic percent of TiB₂ powder of less than 5 micron diameter may be vaporized and then condensed with the AlMgB₁₄ to enhance hardness of the deposited composition. [Tian, Y., M. Womack, et al. (2002). “Microstructure and nanomechanical properties of Al—Mg—B—Ti films synthesized by pulsed laser deposition.” Thin Solid Films 418(2): 129-35]
¹ Amiya, K. and A. Inoue (2000). Thermal stability and mechanical properties of Mg—Y—Cu—M (M=Ag, Pd) bulk amorphous alloys. Materials Transactions, JIM, Japan Institute of Metals, Sendai, Japan. 41: 1460-1462.
² Wang, L., C. Li, et al. (2002). “Formation of Zr70Ni23Ti7 glassy alloy and phase transformation upon annealing.” Journal of Materials Research 17(3 March): 693-696.
³ Kimura, H., A. Inoue, et al. (2000). Production and mechanical properties of Zr-based metallic glassy wires. Funtai Oyobi Fummatsu Yakin/Journal of the Japan Society of Powder and Powder Metallurgy, Funtai Funamtsu Yakin Kyokai/Japan Soc. of Powder Metallurgy, Kyoto, Japan. 47: 427-432.
⁴ Sordelet, D. J., E. Rozhkova, et al. (2003). “Consolidation of gas atomized Cu47Ti34Zr11Ni8 amorphous powders.” Journal of Non-Crystalline Solids Advances in Metallic Glasses, Feb. 17-21, 2002 317(1-2 Mar. 2003): 137-143.
⁵ Zhang, Q. S., H. F. Zhang, et al. (2003). “Bulk metallic glass formation of Cu—Zr—Ti—Sn alloys.” Scripta Materialia 49(4): 273-278.
⁶ Jeng, I.-K., P.-Y. Lee, et al. (2002). “Mechanical alloyed Ti—Cu—Ni—Si—B amorphous alloys with significant supercooled liquid region.” Intermetallics 10(11-12 Nov. 2002): 1271-1276.
⁷ Zhang, T. and A. Inoue (2001). “Ti-based amorphous alloys with a large supercooled liquid region.” Materials Science and Engineering A 304-306(1-2 May 31, 2001): 771-774.
⁸ Zhang, T. and A. Inoue (1999). “Preparation of Ti—Cu—Ni—Si—B amorphous alloys with a large supercooled liquid region.” Materials Transactions, JIM 40(4 April): 301-306.
⁹ Shen, B., H. Koshiba, et al. (2001). “Bulk glassy Co43Fe20Ta5.5B31.5 alloy with high glass-forming ability and good soft magnetic properties.” Materials Transactions 42(10 October): 2136-2139.
¹⁰ Zhang, T. and A. Inoue (2001). “Bulk glassy alloys in (Fe, Co, Ni)—Si—B system.” Materials Transactions 42(6): 1015-1018.
¹¹ Xu, M., M. X. Quan, et al. (2002). “Formation of amorphous Fe62Co6Zr6Nb4Cr2B20 alloy with a remarkable supercooled liquid region before crystallization.” Physica B: Condensed Matter 315(1-3 April): 96-100.
¹² XU, M., M. X. Quan, et al. (2002). “Thermal stability and magnetic properties of amorphous Fe-based alloys with significant supercooled liquid region.” Journal of Alloys and Compounds 334(1-2 February 28): 238-242.
¹³ Inoue, A. and B. Shen (2002). “Formation and soft magnetic properties of Fe—B—Si—Zr bulk glassy alloys with high saturation magnetization above 1.5 T.” Materials Transactions 43(9 Sep. 2002): 2350-2353.
¹⁴ Asami, K., S.-J. Pang, et al. (2002). “Preparation and corrosion resistance of Fe—Cr—Mo—C—B—P bulk glassy alloys.” Journal of the Electrochemical Society 149(8 Aug. 2002): B366-B369.
¹⁵ Shen, B., H. Kimura, et al. (2001). Bulk glassy Fe—Ga—P—C—B alloys with high saturation magnetization and good soft magnetic properties synthesized by fluxing treatment and copper mold casting. Materials Transactions, Japan Institute of Metals. 42: 660-663.
¹⁶ Inoue, A., S. Yoshida, et al. (2001). Structure and soft magnetic properties of bulk Fe—Al—Ga—P—C—B—Si glassy alloys prepared by consolidating glassy powders. Supercooled Liquid, Bulk Glassy and Nanocrystalline states of Alloys, Nov. 27-30, 2000, Boston, Mass., Materials Research Society
¹⁷ Zhang, W., M. Matsusita, et al. (2000). Effect of Dy addition on the thermal stability and magnetic properties of the Fe—Co—Nd—B amorphous alloys with supercooled liquid region. Materials Transactions, JIM, Japan Institute of Metals, Sendai, Japan. 41: 696-700.
¹⁸ Shen, B.-L., H. Koshiba, et al. (2000). “Bulk amorphous Fe—Ga—P—B—C alloys with a large supercooled liquid region.” Materials Transactions, JIM 41(7 July): 873-876.
¹⁹ Zhang, W. and A. Inoue (1999). “Thermal and magnetic properties of Fe—Co—Ln—B (Ln=Nd, Sm, Tb or Dy) amorphous alloys with high magnetostriction.” Materials Transactions, JIM 40(1 January): 78-81.
²⁰ Zhang, W., K. Fujita, et al. (1999). “Synthesis of Fe—Co—Nd—B amorphous alloys with glass transition and their crystallization-induced hard magnetic properties.” Materials Transactions, JIM 40(10 October): 1123-1129.
²¹ Mizushima, T., K. Ikarashi, et al. (1999). “Soft magnetic properties of ring shape bulk glassy Fe—Al—Ga—P—C—B—Si alloy prepared by copper mold casting.” Materials Transactions, JIM 40(9 September): 1019-1022.
²² Koshiba, H., A. Inoue, et al. (1999). “Fe-based soft magnetic amorphous alloys with a wide supercooled liquid region.” Journal of Applied Physics Proceedings of the 43rd Annual Conference on Magnetism and Magnetic Materials, Nov. 9-Nov .12, 1998 85(811 A): 5136-5138.
²³ Poon, S. J. et al, “Glass formability of ferrous-and aluminum-based structural metallic alloys”, Journal of Non-Crystalline Solids 317 (2003) p. 1-9
²⁴ El-Eskandarany, M. S., W. Zhang, et al. (2003). “Mechanically induced crystalline-glassy phase transformations of mechanically alloyed Ta55Zr10Al10Ni10Cu15 multicomponent alloy powders.” Journal of Alloys and Compounds 350(1-2 Feb. 17, 2003): 222-231.
²⁵ Zhang, W. and A. Inoue (2003). “Formation and mechanical properties of Ni-based Ni—Nb—Ti—Hf bulk glassy alloys.” Scripta Materialia 48(5): 641-645.
²⁶ Choi-Yim, H., D. Xu, et al. (2003). “Ni-based bulk metallic glass formation in the Ni—Nb—Sn and Ni—Nb—Sn—X (X=B, Fe, Cu) alloy systems.” Applied Physics Letters 82(7 Feb. 17, 2003): 1030-1032.
²⁷ Lee, P.-Y., S.-S. Hung, et al. (2002). “Consolidation of amorphous Ni—Zr—Ti—Si powders by vacuum hot-pressing method.” Intermetallics 10(11-12 Nov. 2002): 1277-1282.
²⁸ Wang, X., I. Yoshii, et al. (1999). “Bulk amorphous Ni75-xNb5MxP20-yBy (M=Cr, Mo) alloys with large supercooling and high strength.” Materials Transactions, JIM 40(10 October): 1130-1136.
²⁹ Lee, P. Y., C. K. Lin, et al. (1999). “Formation of Cu—Zr—Ti amorphous alloys with significant supercooled liquid region by mechanical alloying.” Materials Science Forum Proceedings of the 1998 International Symposium on Metastable, Mechanical Alloyed and Nanocrystalline Materials, ISMANAM-98,Dec. 7-Dec. 12, 1998 312: 67-72.
³⁰ Li, C., J. Saida, et al. (2000). “Dynamic crystallization process in a supercooled liquid region of Cu40Ti30Ni15Zr10Sn5 amorphous alloy.” Journal of Non-Crystalline Solids 261(1-3 January): 108-114.
³¹ Kawamura, Y., T. Nakamura, et al. (1999). Deformation behavior in La55Al25Ni20 metallic glass. Proceedings of the 1998 MRS Fall Meeting—Symposium MM on ‘Bulk Metallic Glasses’,Dec. 1-Dec. 3, 1998. Boston, Mass., U.S.A., Materials Research Society, Warrendale, Pa. , U.S.A. 554: 373-378.
³² S. Joseph Poon, et. al, “Glass formability of ferrous-and aluminum-based structural metallic alloys”, Journal of Non-Crystalline Solids vol. 317 pp. 1-9 (2003)
³³ I-Kimura, H., A. Inoue, et al. (1999). “Production and mechanical properties of Al—M (M=Cr, V, Ti) base alloys containing aperiodic nano-particles.” Funtai Oyobi Fummatsu Yakin/Journal of the Japan Society of Powder and Powder Metallurgy 46(12 December): 1327-1333
³⁴ Rodrigues, C. A. D., A. R. Yavari, et al. (2003). “Milling and hot consolidation of Al—Fe—Nb alloy.” Materials Science Forum 416-418(1): 287-292
³⁵ Munoz-Morris, M. A., S. Surinach, et al. (2003). “Crystallization of a Al4Ni-6Ce glass and its influence on mechanical properties.” Acta Materialia 51(4) Feb 25, 2003): 1067-1077
³⁶ Louzguine, D. V., A. R. Yavari, et al. (2003). “Mischmetal as an alloying addition to amorphous materials and glass formers.” Journal of Non-Crystalline Solids 316(2-3 Feb. 2003): 255-260
³⁷ Sa Lisboa, R. D. and C. S. Kiminani (2002). “Primary crystallization in amorphous Al84Ni8Co4Y3Zr1 alloy.” Journal of Non-Crystalline Solids 304(1-3 June): 36-43
³⁸ Gibson, M. A. and C. J. Bettles (2002). Crystallisation of an amorphous Al75Ni21Y4 alloy melt-spun ribbon. Materials Letters, Elsevier Science B.V. 57: 982-987
³⁹ Zhang, C., Y. Wu, et al. (2001). “The crystallization behavior of amorphous Al90Fe5Ce5 alloy.” Journal Of Materials Science Letters 20: 1415-1417
⁴⁰ Kiminami, C. S., N. D. Basim, et al. (2001). “Challenges in the development of aluminium-based bulk amorphous alloys.” Key Engineering Materials, 2nd International Latin-American Conference on Powder Technology 189-191: 503-508
⁴¹ Kamiyama, T., H. Kimura, et al. (2001). “A SAXS study of rapidly solidified Al-base amorphous alloys containing nanometer-scale precipitates.” Scripta Materialia 44(8-9 May 18): 1297-1301
⁴² Sasamori, K., H. Kimura, et al. (2000). Mechanical properties and mnicrostructures of melt-quenched Al—Fe—Ti—M (M=V, Cr, Mn) alloys. Funtai Oyobi Fummatsu Yakin/Journal of the Japan Society of Powder and Powder Metallurgy, Funtai Funamtsu Yakin Kyokai/Japan Soc. of Powder Metallurgy, Kyoto, Japan. 47: 417-422
⁴³ Ping, D. H., K. Hono, et al. (2000). Microstructural characterization of a rapidly solidified ultrahigh strength Al94.5Cr3Co1.5Ce1 alloy. Metallurgical and Materials Transactions A: Physical Metallurgy and Materials Science, Minerals, Metals and Materials Society, USA. 31A: 607-614
⁴⁴ Kimura, H., A. Inoue,. et al. (1 999). “Production and mechanical properties of Al—M (M=Cr, V, Ti) base alloys containing aperiodic nano-particles.” Funtai Oyobi Funnatsu Yakini/Journal of the Japan Society of Powder and Powder Metallurgy 46(12 December): 1327-1333.
⁴⁵ Cardoso, K. R., A. G. Escorial, et al. (1999). “Al—Fe—Nd Powders prepared by gas atomization.” Journal of Metastable and Nanocrystalline Materials 2-6: 253-258
⁴⁶ Louzguine, D. V. and A. Inoue (1998). Precipitation of nanogranular Ge particles in rapidly solidified Al—Si—Fe—Cr—Ge alloys. Materials Transactions, JIM, Japan Inst of Metals, Sendai, Japan. 39: 504-507
⁴⁷ Kimura, H., L. Wang, et al. (1998). Formation, thermal stability and mechanical properties of new amorphous Al89Fe10Zr1 alloy. Materials Transactions, JIM, Japan Inst of Metals, Sendai, Japan. 39: 866-869
⁴⁸ Kimura, H., K. Sasamori, et al. (1998). “New amorphous alloys in Al—Ti binary system.” Materials Transactions, JIM 39(7 July): 773-777
⁴⁹ ITsai, A. P., T. Kamiyama, et al. (1997). “Formation and precipitation mechanism of nanoscale Al particles in Al—Ni base amorphous alloys.” Acta Materialia 45(4 April): 1477-1487
⁵⁰ Inoue, A., H. Kimura, et al. (1997). Deformation and fracture behavior of high-strength Al94(V, Ti)4Fe2 and Al93Ti5Fe2 alloys consisting of nanogranular amorphous and Al phases. Chemistry and Physics of Nanostructures and Related Non-Equilibrium Materials Proceedings of the 1997 TMS Annual Meeting, Feb. 9-13, 1997, Orlando, Fla., U.S.A., Minerals, Metals &amp; Materials Soc (TMS),Warrendale, Pa. ,U.S.A.
⁵¹ Inoue, A. and H. Kimura (1997). “High-strength Al-based alloys consisting mainly of nanoscale quasicrystalline or amorphous particles.” Materials Science Forum Synthesis and Properties of Mechanically Alloyed and Nanocrystalline Materials Proceedings of the 1996 International Symposium on Metastable, Mechanically Alloyed and Nanocrystalline Materials, May 20-24, 1996 235-238(pt 2): 873-880
⁵² Escorial, A. G., B. Sanchez, et al. (1991). Rapidly solidified Al-3Cr—X (Ni, Mo) ribbons. Structure and decomposition behaviour. Structural Materials: Properties, Microstructure and Processing Materials Science & Engineering A: Structural Materials: Properties, Microstructure and Processing Proceedings of the Seventh International Conference on Rapidly Quenched Materials, Aug. 13-17, 1990. Stockholm, Swed. A134: 1204-1207
⁵³ Takagi, M., H. Ohta, et al. (2001). “Wear properties of nanocrystalline aluminum alloys and their composites.” Scripta Materialia 44(8-9 May 18): 2145-2148
⁵⁴ Louzguine, D. V., A. Takeuchi, et al. (1997). “New amorphous alloys in Al—Si—Fe—Ni and Al—Si—Fe—Co systems and their crystallization behaviour.” Materials Transactions, JIM 38(7 Jul): 595-598
⁵⁵ Louzguine, D. V. and A. Inoue (1997). “Effect of Ge addition to Si50-55Al25-20Fe10Ni5Cr5Zr5 alloys obtained by melt spinning.” Nanomaterials Nanostructured Materials, Proceedings of the 1997 4th International Union of Materials Research Societies, IUMRS, September 1997 8(8 December): 1007-1013
⁵⁶ Louzguine, D. V. and A. Inoue (1997). “Multicomponent Si-based amorphous alloys produced by melt spinning and their crystallization behaviour.” Materials Transactions, JIM 38(12 December): 1095-1099.
⁵⁷ Louzguine, D. V. and A. Inoue (1997). “Multicomponent Si-based amorphous alloys produced by melt spinning and their crystallization behaviour.” Materials Transactions, JIM 38(12 December): 1095-1099
⁵⁸ Louzguine, D. V. and A. Inoue (1999). “Influence of cooling rate on the formation of an amorphous phase in Si-based multicomponent alloys and its thermal stability.” Materials Research Bulletin 34(7 May): 1165-1172
⁵⁹ Inoue, A., N. Nishiyama, et al. (1994). “New amorphous alloys in Al—Ca and Al—Ca—M (M=Mg or Zn) systems.” Materials Transactions, JIM 35(4 April): 282-285
⁶⁰ Kawamura, Y., K. Hayashi, et al. (2000). “High strength nanocrystalline Mg—Al—Ca alloys produced by rapidly solidified powder metallurgy processing.” Materials Science Forum, Proceedings of the 1 st Nagaoka International Workshop on Magnesium Platform Science and Technology 2000,Jul. 27-Jul. 29, 2000 350: 111-116

1. A method for applying an amorphous metal alloy to a substrate, comprising the step of:
vaporizing an amorphous metal alloy composition, in a plasma spray gun, and condensing and solidifying the amorphous metal alloy composition vapor on the substrate to form the amorphous metal layer.
